(19) United States
(12) Patent Application Publication
(10) Pub. No.: US 2008/0156594 A1
(43) Pub. Date: Jul. 3, 2008

(54) Electromagnetic Brake Device

(76) Inventor: Kiyoto Kobayashi, Nagano (JP)

Correspondence Address: FLYNN THIEL BOUTELL & TANIS, P.C., 2026 RAMBLING ROAD, KALAMAZOO, MI, 49008-1631, US

(21) Appl. No.: 11/885,823

(22) PCT Filed: Mar. 28, 2005
(86) PCT No.: PCT/JP2005/005669

§ 371 Date: Sep. 6, 2007

(51) Int. Cl. F16D 55/224

(52) U.S. Cl. 188/72.3

(57) ABSTRACT

A deenergization operation type electromagnetic brake device (1), comprising a plurality of conical springs (8) for pressing an armature disk (5) against a fixed disk (7) through a friction disk (6) held therebetween. The conical springs (8) are inserted into the spring insertion recessed parts (15) of the yoke (11) of an electromagnet (4), and held between the bottom faces of the recessed parts and the armature disk (5) in a compressed state. Since the conical springs (8) are shorter than cylindrically coiled springs in a compressed state, the spring insertion recessed parts (15) can be made shallower and the thickness of the yoke (11) determined by the recessed parts can be reduced. As a result, the electromagnetic brake device (1) can be advantageously formed flat.

### TECHNICAL FIELD

The present invention relates to a flat deenergization operation type electromagnetic brake device that can be attached to a motor output shaft or other rotating shaft in order to restrict rotation.

### BACKGROUND ART

Deenergization operation type electromagnetic brake devices are known as devices for imparting a braking force to a motor output shaft or other rotating shaft. The deenergization operation type magnetic device comprises a friction disk having frictional surfaces formed on either surface. A fixed disk is disposed on one side of the friction disk so as not to move in the direction of the axial line of the device, and an armature disk that is able to be attracted by an electromagnet is disposed on the opposite side of the friction disk. A compression coil spring is held between the armature disk and the electromagnet.

The friction disk is attached to a rotating shaft so as to integrally rotate in a state allowing sliding in the direction of the central axis line of the shaft. When the electromagnet is in an “off” state, the compression coil spring causes the armature disk to press against the fixed disk, with the friction disk held therebetween. The frictional force generated between the disks by the pressing force of the compression coil spring restricts the rotation of the rotating shaft. When the electromagnet is energized, the armature disk is attracted against the spring force of the compression coil spring, and the friction disk assumes a released state. The restriction on the rotating shaft is accordingly canceled.

In order for an electromagnetic braking device of this structure to be made flatter; i.e., to be made thinner in the shaft direction, it is useful to reduce the thickness of the electromagnet, which is the thickest of the components. The electromagnet is composed of a yoke and an excitation coil mounted therein. A spring insertion recessed part is formed in an end surface of the yoke, facing the armature disk, and the compression coil spring inserted therein is held between the armature disk and a bottom surface of the spring insertion recessed part. The yoke must be made thinner in order to make the electromagnet thinner; therefore, the thickness of the mounted part of the excitation coil formed in the yoke and the thickness (depth) of the spring insertion recessed part need to be reduced.

In order to make the mounted portion of the excitation coil thinner, the square conductive wire is used to wound regularly for the excitation coil instead of using the more common round conductive wire, or another method may be adopted. However, it is difficult to reduce the thickness (depth) of the spring insertion recessed part into which the compression coil spring is inserted. Specifically, in order for the spring force of the compression coil spring to be stabilized, the compression coil spring must be inserted to a certain length. The depth of the spring insertion recessed part must accordingly correspond to this length. The yoke must also have a thickness that is equal to or greater than a prescribed value so as to allow a spring insertion recessed part of a prescribed depth to be formed, and cannot be made thinner

### DISCLOSURE OF THE INVENTION

An object of the present invention is to provide a flat electromagnetic brake device.

Accordingly, an electromagnetic brake device of the present invention is characterized in comprising
a friction disk;
a fixed disk disposed on one side of the friction disk in a fixed position in a direction of the central axial line of the device;
an armature disk disposed on the other side of the friction disk in a state allowing sliding in the direction of the central axial line of the device;
a compression coil spring for urging the armature disk toward the friction disk; and an electromagnet able to attract the armature disk against a spring force of the compression coil spring; wherein
the compression coil spring has a configuration wherein the coiled portion gradually increases or decreases in diameter in the direction of the central axial line; and
the friction disk is designed to be attached to a rotating shaft that is to be controlled so that the disk will integrally rotate in a state allowing sliding in the direction of the central axis line of the shaft.

A conical spring can be used as the compression coil spring in the present invention.

In such a case, the conical spring is preferably one in which, under compression, the diameter of the coiled portions gradually increases or decreases from one end to the other end so that one of the adjacent coiled portions substantially moves within the other coiled portion.

Next, as the electromagnet, an electromagnet can be used which comprises
a yoke having a round end surface for magnetically chucking the armature disk;
an annular coil insertion recessed part formed on the round end surface;
a spring insertion recessed part formed at equidistant intervals in the same circle on the round end surface;
an excitation coil mounted on the coil insertion recessed part;
and said compression coil spring, which is inserted into the spring insertion recessed parts and held between a bottom surface of the recessed part and an end surface of the armature disk.

The compression coil spring used in the deenergization operation type electromagnetic brake device of the present invention is one that has a configuration wherein the coiled portions gradually increase or decrease in diameter in the direction of the central axial line, as with conical springs or the like. When a coil spring with this type of configuration is compressed, the coils overlap each other in a spiral form in a state in which one of the adjacent coiled portions moves within the other coiled portion. It is accordingly possible to achieve compression that exceeds the length obtained by multiplying the coil diameter by the number of windings. Conversely, typical cylindrical compression coil springs have adjacent coiled portions of the same diameter; therefore, under compression, the adjacent portions come into contact with each other and are unable to undergo any further compression. In other words, it is impossible to achieve compression that exceeds the length obtained by multiplying the coil diameter by the number of windings.

The compression length of conical springs can thus be made adequately shorter than the compression length of cylindrically coiled springs, even when both have the same number of windings. Consequently, the spring insertion recessed part formed in the yoke used for inserting the conical spring can be made shallower. The yoke can be made thinner as a result; therefore, the electromagnet can be made thinner, and in turn the electromagnetic brake device can be made thinner.

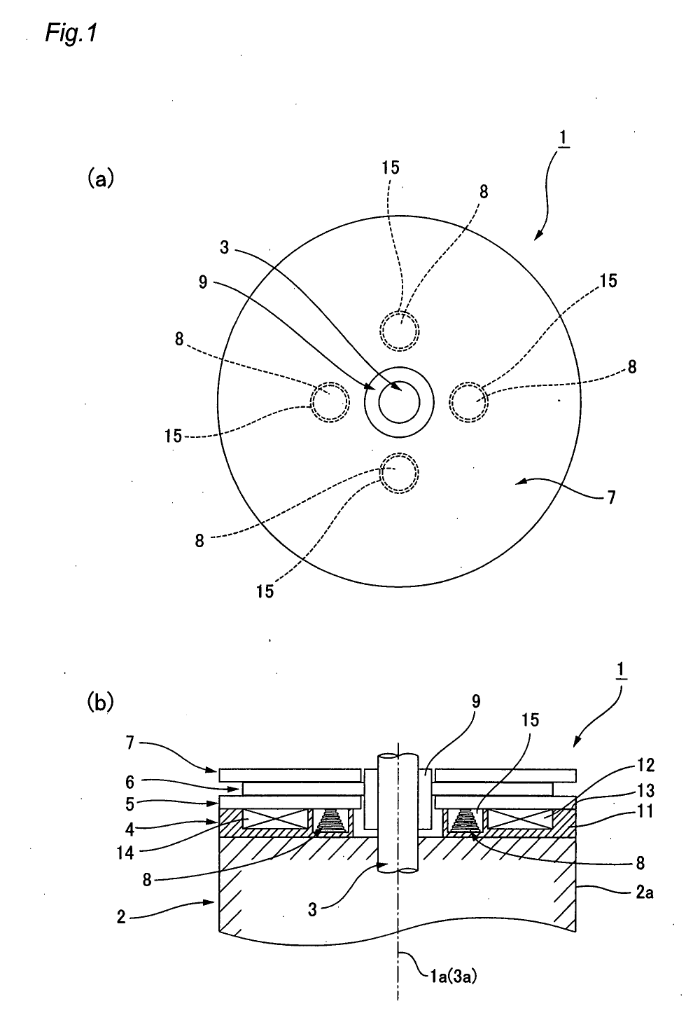

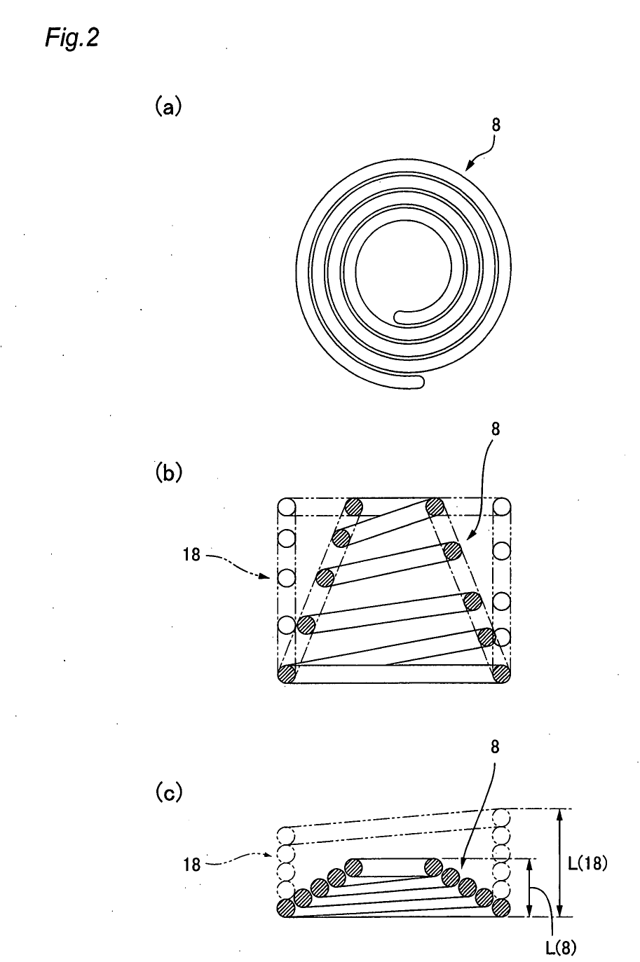

### BRIEF DESCRIPTION OF THE DRAWINGS

[FIGS. 1(a) and (b)] are a front view and a longitudinal cross-sectional view of a deenergization operation type electromagnetic brake device to which the present invention applies; and

[FIGS. 2(a) through (c)] are a top view showing a conical spring, a vertical cross-sectional view of a conical spring in an elongated state, and a vertical cross-sectional view of a conical spring in a compressed state.

### BEST MODE FOR CARRYING OUT THE INVENTION

Described below is an example of a deenergization operation type electromagnetic brake device to which the present invention has been applied, with reference being made to the accompanying drawings.

FIGS. 1(a) and (b) are a front view and vertical longitudinal cross-sectional view of the deenergization operation type electromagnetic brake device to which the present invention is applied. The deenergization operation type electromagnetic brake device 1 of this example is attached to a rotating shaft 3 of a motor 2, and is used to switch the rotation of the rotating shaft 3 to a restricted state (braked state) or a free state (unbraked state).

The deenergization operation type electromagnetic brake device 1 comprises an electromagnet 4 arranged in a coaxial state in the direction of an axial line 1a of the device, an armature disk 5, a friction disk 6, and a fixed disk 7. A plurality of conical springs 8 are disposed between the electromagnet 4 and the armature disk 5. The armature disk 5 is constantly urged toward the friction disk 6 by the conical springs 8.

The friction disk 6 has frictional surfaces formed on either side and is fixed in a coaxial state to a cylindrical hub 9. The cylindrical hub 9 is attached to the rotating shaft 3 so as to integrally rotate in a state allowing sliding in the direction of the central line of rotation 3a thereof (device axial line 1a). The armature disk 5 is supported in a state allowing sliding in the direction of the device axial line 1a using a guide (not shown) attached to the electromagnet 4.

The fixed disk 7 placed opposite the front side of the friction disk 6 is fixed in a non-rotating state in a prescribed position in the direction of the device axial line 1a. A state is accordingly formed wherein the spring force of the conical springs 8 presses the armature disk 5 against fixed disk 7, with the friction disk 6 held therebetween. In this state (wherein the electromagnet 4 is deenergized), a prescribed pressing force is used to hold the friction disk 6, which rotates integrally with the rotating shaft 3, between the fixed disk 7 and the armature disk 5, and the rotation of the rotating shaft 3 is restricted by the frictional force generated between the disks.

The electromagnet 4 disposed on the rear side of the armature disk 5 comprises a yoke 11 and an excitation coil 12. The yoke 11, which has an annular configuration overall, is fixed to the housing 2a of the motor 2 in a coaxial state. A front end surface 13 of the yoke 11 is a chucking surface of the armature disk 5, and an annular recessed part 14 of fixed depth is formed therein. The excitation coil 12 is installed in the annular recessed part 14. A square conductive wire is wound regularly to form the excitation coil 12 in this example. Less mounting space is required for the excitation coil 12 when square conductive wire is used as compared to when round conductive wire is used, although the same number of windings is used. Therefore, the annular recessed part 14 can be made shallower. Once the excitation coil 12 has been installed therein, the annular recessed part 14 is packed with an insulating material or the like, and thereby sealed.

Four round spring insertion recessed parts 15 are formed at equidistant intervals in the same circle in the interior of the annular recessed part 14 on the front end surface 13 of the yoke 11. The conical springs 8 are inserted in each spring insertion recessed part 15. In this example, the conical springs 8 are inserted so that an end thereof on the large diameter side will be positioned in the bottom surface side of the recessed part. When in an elongated state, the conical springs 8 have a length dimension that is greater than the depth of the spring insertion recessed part 15.

A description is provided hereunder of the operation of the deenergization operation type electromagnetic brake device 1 having the above configuration. In a deenergized state, the electromagnet 4 does not produce a magnetic attraction force; therefore, the spring force of the conical springs 8 causes the armature disk 5 to press the friction disk 6 against the fixed disk 7. In this state, a prescribed pressing force is used to hold the friction disk 6, which rotates integrally with the rotating shaft 3, between the fixed disk 7 and the armature disk 5, and the rotation of the rotating shaft 3 is restricted by the frictional force generated between the disks.

When the electromagnet 4 is energized, the armature disk 5 moves against the spring force of the conical springs 8, and is magnetically attracted to and chucked on the front end surface 13 of the electromagnet. The conical springs 8 are compressed by the armature disk 5 to the length dimension corresponding to the depth of the spring insertion recessed part 15. The friction disk 6 is switched to a released state, and the brake force acting on the rotating shaft 3, which integrally rotates with the friction disk 6, is cancelled.

FIG. 2 shows a top view of the conical springs 8, a longitudinal cross-sectional view thereof in an elongated state, and a longitudinal cross-sectional view thereof in a compressed state. The conical shape of the conical springs 8 in this example is stipulated so that one of the adjacent coiled portions substantially moves within the other coiled portion. In the case of the cylindrically coiled springs 18 indicated by an imaginary line in the drawing, adjacent coiled portions of the same diameter are unable to undergo any further compression when coming into contact with each other. In other words, it is impossible to achieve any compression beyond the length dimension L (18), which is obtained by multiplying the coil diameter by the number of windings.

Conversely, in the case of the conical springs 8, compression can be achieved to a length measurement L(8) that is shorter than the length measurement obtained by multiplying the coil diameter by the number of windings. Therefore, when the conical springs 8 are used, the depth of the spring insertion recessed part 15 into which the coil springs are to be inserted can be made shallower, and the yoke 11, whose thickness is stipulated by the depth of the recessed part 15, can accordingly be made thinner. The overall thickness of the electromagnetic brake device 1 can be reduced as a result.

### OTHER EMBODIMENTS

It is possible for the conical springs 8 to be substituted by coil springs having an hourglass shape, wherein the diameter gradually decreases from either end towards the center; coil springs having a barrel shape, wherein the diameter gradually increases from either end towards the center; or other coil springs.

A disk having frictional surfaces formed on either side thereof was used for the frictional disk 6. However, as an alternative, frictional surfaces can be formed on the armature disk surface facing the friction disk, and on the fixed disk surface facing the friction disk.

1. An electromagnetic brake device, characterized in comprising:
a friction disk;
a fixed disk disposed on one side of the friction disk in a fixed position in a direction of a device central axial line;
an armature disk disposed on the other side of the friction disk in a state allowing sliding in the direction of the device central axial line;
a compression coil spring for urging the armature disk toward the friction disk; and
an electromagnet able to attract the armature disk against a spring force of the compression coil spring; wherein
the compression coil spring has a configuration wherein the coiled portion gradually increases or decreases in diameter in the direction of a central axial line; and
the friction disk is attached to a rotating shaft that is to be controlled so that the disk will integrally rotate in a state allowing sliding in the direction of a central axis line of the shaft.

2. The electromagnetic brake device according to claim 1, characterized in that the compression coil spring is a conical spring.

3. The electromagnetic brake device according to claim 2, characterized in that the conical spring, on being compressed, gradually increases or decreases in diameter from one end of the coiled portion to the other end so that one of the adjacent coiled portions substantially moves within the other coiled portion.

4. The electromagnetic brake device according to claim 1, characterized in that the electromagnet comprises:
a yoke having a round end surface for magnetically chucking the armature disk;
an annular coil insertion recessed part formed on the round end surface;
a spring insertion recessed part formed at equidistant intervals in the same circle on the round end surface;
an excitation coil mounted on the coil insertion recessed part; and
said compression coil spring, which is inserted into the spring insertion recessed parts and held between a bottom surface of the recessed part and an end surface of the armature disk.
